(19) United States
(12) Patent Application Publication
(10) Pub. No.: US 2018/0015477 A1
(43) Pub. Date: Jan. 18, 2018

(54) PLASTIC SHREDDER

(71) Applicant: Calvin Moore, Newark, NJ (US)

(72) Inventor: Calvin Moore, Newark, NJ (US)

(21) Appl. No.: 15/211,192

(22) Filed: Jul. 15, 2016

(51) Int. Cl. B02C 18/08; B02C 18/22; B29B 17/04; B29K 105/26

(52) U.S. Cl. CPC B02C 18/086; B29B 17/04; B02C 18/2283; B02C 2201/06; B29B 2017/0444; B29K 2105/26

(57) ABSTRACT

A bottle shredder is disclosed. The bottle shredder features a bottle holder, sized to receive a plastic bottle, a wire cutter and bottle support, both of which are located below the bottle holder. The bottle holder is attached to a linear slide, which is capable of moving the bottle holder directly above a shredding apparatus. The shredding apparatus contains at least one feed roller operatively connected to a first motor, a spur gear, a bearing block, featuring at least one bearing, and at least one shredding blade operatively connected to a second motor via the spur gear and bearing block. Below the shredding apparatus is a finished shreds chute, which collects the post-shredded bottle parts.

### CLAIM OF PRIORITY

This application does not claim priority to any patent or patent application.

### FIELD OF THE EMBODIMENTS

The field of the present invention and its embodiments relate to a plastic shredding apparatus, in particular, a plastic bottle shredding apparatus that generates shreds of plastic that are optimized for recycling.

### BACKGROUND OF THE EMBODIMENTS

While humans have been recycling since as early as 400 BC, what has been recycled and how humans have gone about recycling it has changed dramatically. With concerns rising over the environmental impact of waste buildup and the threats that landfills pose to public safety, both state and local governments have increased funding for recycling services. As the production of plastics continues to increase, the need for improved recycling services is needed.

As it stands today, there is room for improvement in recycling. Collecting, sorting, processing, and reusing recyclable materials is a time consuming process. When recycling plastics in particular, the plastics are melted down so that they can be put into a usable state. Typically, when these plastics are melted together, they will phase separate and then solidify in various layers, similar to an oil/water emulsion. Due to this property, plastics need not be completely sorted before they are melted down for recycling purposes.

For this reason, it is possible to melt plastics of various types together, and then subsequently separate them. Based on this, it would be possible to shift the shredding of the plastic bottles to end-consumers and then transport the pre-shredded plastic to a recycling center for subsequent melting. This system could provide significant savings over the existing recycling paradigm. As such, there exists a need for a device that can quickly and efficiently shred plastic that is small enough to fit in a user's home.

Review of Related Technology:

U.S. Pat. No. 5,092,234 pertains to a container crusher for crushing aluminum beverage cans, two-liter plastic beverage bottles, and the like uses a motor-driven rotatable drum in a housing. Mounted on the periphery of the drum are a plurality of angled crusher arms which contact containers introduced into the housing and crush them between the rotating crusher arms and the walls of the housing. Mounted on top of the housing is a circular tray into which containers to be crushed are placed. The tray has a feed opening into the crusher housing which is covered by a safety cover which, in turn, has an inlet opening displaced from the feed opening. Containers are introduced into the feed opening of the safety cover which is sized and positioned so as to prevent an operator's hand from entering the crusher housing. The crusher unit can be directly attached to a conventional 40-gallon trash can, or, alternatively, can be placed inside a conventional 55-gallon drum.

U.S. Pat. No. 5,125,333 pertains to a device for crushing cans and cutting plastic containers to facilitate efficient, space-saving storage, compact disposal, and recycling of the material. The device includes a rigid base member adapted for placement on a level surface, a handle plate portion pivotally connected to the base member and adapted for crushing cans, a handle projecting outwardly from the handle plate portion and adapted for manual gripping, and a longitudinally-extending groove located on the base member. A pair of oppositely-disposed sculpted recesses for holding a can upright while the handle plate portion is pivoted downward for engaging and crushing the can are located adjacent the groove. A removable crushing plate is adapted for placement over the groove to support a can positioned lengthwise thereon for crushing by the handle plate portion. Projecting up through the groove is a rotary blade which is driven by a motor unit located within the base member. When the crushing plate is removed, a plastic container can be positioned and held lengthwise in the groove, whereupon it can be cut into small strips or pieces by manually turning the container upon the rotating blade. The device also includes a protective shield which is adapted for pivotal movement upward or downward to selectively cover and uncover the blade.

U.S. Pat. No. 5,381,732 pertains to a can crusher, being motorized, and self contained, and having distinguishing capability between glass, plastic, and metal cans, or bottles, and having storage capability in the bottom of the cabinet which houses the can crushing apparatus.

U.S. Pat. No. 7,546,965 pertains to a domestic plastic bottle shredding machine. The machine has a hydraulic ram assembly located above the shredding mechanism so that any plastic, glass, paper, or aluminum that is introduced will be flattened prior to being shredded. A waste bin is located beneath the shredding mechanism such that the storage process is driven by gravity. The machine is designed for domestic uses such that the shape of the machine resembles a small garbage can. The primary feature of this invention is to aid the recycling process by shredding plastic, glass, paper, or aluminum in advance of the recycling process.

U.S. Pat. No. 7,856,860 pertains to a device and method for flattening bottle caps from beverage containers. In a preferred embodiment of the invention, the bottle cap flattener includes a bottle cap positioner, a bottle cap holder, a bottle cap flattening tool, a motor and a positioning jig. The bottle cap positioner precisely locates a bottle cap so that the bottle cap flattening tool can interact with the bottle cap to flatten the bottle cap. The bottle cap positioner preferably includes a rotatable disk that is rotated by the motor. The bottle cap flattening tool applies pressure to a bottle cap through a tip to force the outer portion of the bottle cap into a flattened configuration along with the central portion of the bottle cap. The bottle cap holder applies force to a bottle cap located on the bottle cap positioner to hold the bottle cap in a precise relationship with the bottle cap positioner. Where the bottle cap positioner includes a rotating disk, the bottle cap holder applies force to a bottle cap located on the disk to hold the bottle cap on the disk. The positioning jig precisely locates the bottle cap on the friction surface of the disk so that the bottle cap can be acted on by the bottle cap flattening tool.

U.S. Pat. No. 8,104,401 pertains to a plastic bottle crushing that includes a housing having a slidable tray that is positioned underneath the bottle to be crushed in order for any remaining liquids contained within said bottle to be collected. The housing also includes a bottom crushing surface that has a hole in order to support the top portion of the plastic bottle in an inverted position. The invention may be either manually operated or by an automated mechanical means.

U.S. Pate. No. 8,763,941 pertains to an apparatus provided for reducing the volume of trash generated from plastic bottles and containers whether destined for landfill or not. The apparatus includes a shredder mounted within an aesthetically pleasing and functionally suggestive beverage bottle shaped housing. A chute with a plunger is provided which forces the plastic bottles against blades rotated on a substantially horizontally mounted disk with a fan for directing the shredded particles into a duct for transport to a bin within the bottle shaped housing. A pan structure is provided to collect any fluid remaining in the bottles being shredded and directed via a duct to the bin.

International Patent Document No. WO2008139278 pertains to a device that is primarily used in compacting various used food and drink containers before disposal into waste bins. A vast range of food and drink containers in use today can be substantially reduced in volume before binning when using this device. Containers made of metal, plastic, paper, and cardboard etc. are all suitable for use in Manual ‘V’ Press Home Compactor device. The device can also be readily used as a breadboard/chopping board, as a food crusher for ice cubes, garlic, nuts, pressing flowers and herbs etc. The device when opened out flat can also be used as a serving board for hot pans.

Chinese Patent Document No. CN100577297 pertains to a plastic bottle shredding device. The technique proposal is that: a blanking box, an aggregate box, a machine frame and an extrusion device are arranged in a protecting shell, the blanking box is arranged upon the extrusion device, and the aggregate box is arranged below the extrusion device, the extrusion device is composed of an active knife roll, a driven press roller, a belt pulley, an active knife roll shaft, a driven press roller shaft and an adjustable shelf, the active knife roll, the belt pulley and the active knife roll shaft are arranged on the machine frame; the driven press roller and the driven press roller shaft are arranged on the adjustable shelf, the adjustable shelf push the driven press roller shaft to the active knife roll by a crank arm mechanism, meanwhile, the active knife roll and the driven press roller move towards the same direction by rotating, and introduce the bottle to the middle part of the two rollers, then the bottle is pressed and shredded to fall into the aggregate box. The beneficial effects are: firstly, scrapes occurred on the surface of the crushed plastic by the prior art are avoided, and the application field and range of the plastic fragments are largely extended; secondly, the invention solves problems of high power consumption, loud noise, non unity of granularity, bad product quality, low output, castoff glut and excessive safe hidden troubles.

Chinese Patent Document No. CN101648417 pertains to a turbine type plastic bottle chopping machine which is characterized by comprising a barrel-shaped machine body, wherein the machine body is internally provided with a rotating shaft which is provided with a plurality of turbine cutting mechanisms from top to bottom, and adjacent turbine cutting mechanisms are respectively installed in a direct fixing mode and through a bearing; each turbine cutting mechanism comprises three turbine blades, and an erect high-alloy steel turbine cutting tool with saw-toothed front edge is embedded in each turbine blade; and the outer radian of the turbine blade is the same as the inner radian of the machine body. The invention has simple structure, convenience, practicability, safety, reliability and convenient recovery, storage and transportation.

Chinese Patent Document No. CN201186235 pertains to a drinking bottle shredder which can flatten and shred drinking bottles, which is driven by a motor through a gear wheel and is spirally driven, the rotary motion of a motor is conversed into the horizontal motion of a crush-cutting mechanism, the main body of the crush-cutting mechanism is formed by three square steel plates which are connected by a bolt, a spring which is pressed is mounted on the bolt to form pretightening force, two cutters are mounted on a middle plate, the third plate and the fourth plate are both provided with notches, and cutters can be threaded through the two plates. The cutters are penetrated through the two plates and cut off a plastic bottom between the two plates after two plates are pressed. A feed mechanism is formed by four cramping apparatus which are distributed on a track plane in 90 degrees and a deflector rod which pulls a small collar plate to rotate, and charging can be rotated as the back and forth motion of the main body of the crush-cutting mechanism. The circuit potion achieves the positive inversion of the motor through touching a stroke control switch when the drinking bottle shredder is running. The drinking bottle shredder can reduce the volumes of drinking bottles, which is convenient for recycling and storing, and is suitable for being used by households, hotels and other occasions.

Chinese Patent Document No. CN202097988 pertains to a wall-mounted can crusher with holes. Pressure arms are connected on two side surfaces at the lower end of a base plate respectively through fixed plate rivets; the upper ends of the two pressure arms are connected through a grab handle shaft; a sponge grab handle penetrates the grab handle shaft; the fixed plate rivets penetrate the base plate to cause a fixed plate to be fixed on the inner side at the lower end of the base plate; a movable pressure plate is arranged in a groove at the upper end of the base plate; guide openings are formed on two sides of the movable pressure plate respectively; a circular hole is formed in the middle of the movable pressure plate; connecting sheets are connected on two sides of the movable pressure plate respectively through movable pressure plate rivets; and the lower ends of the connecting sheets are connected with the middle lower ends of the pressure arms through connecting sheet rivets.

Chinese Patent Document No. CN20270443 pertains to an adjusting mechanism for a feed port of a waste plastic bottle crusher, and relates to the technical field of plastic recovering equipment. The mechanism comprises the crusher, and is characterized in that a shell of the feed port of the crusher is connected with a first threaded rod; one end of the first threaded rod is connected to the shell of the feed port of the crusher; the other end of the first threaded rod is connected with a rotating shaft sleeve; the other end of the rotating shaft sleeve is connected with one end of a second threaded rod; and the other end of the second threaded rod is connected to a base of the crusher. The mechanism has a simple structure, is reasonable in design and is very convenient and practical, and the feed port of the crusher can be turned by rotating the rotating shaft sleeve and is maintained and cleaned.

European Patent Document No. EP2212104 pertains to a device for crushing cans, bottles, or similar, comprising a piston device, between the wall of which and the opposing wall of the device the object is crushed, and installed in a casing. The piston can be moved in two directions from its middle position, in order to create two pressing chambers. In the device, there is a crank mechanism connected to a rotatable shaft, for moving the piston.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present invention discloses, a bottle shredder, comprising: a bottle holder, sized to receive a plastic bottle; a wire cutter, located below the bottle holder; bottle support, located below the bottle holder; a linear slide attached to the bottle holder, capable of moving the bottle holder directly above a shredding apparatus, the shredding apparatus comprising: at least one feed roller operatively connected to a first motor, a spur gear, a bearing block, featuring at least one bearing, at least one shredding blade operatively connected to a second motor via the spur gear and bearing block, wherein the at least one feed roller is proximate to the at least one shredding blade; a finished shreds chute, located directly below the shredding apparatus. In some embodiments, the bottle shredder further comprises at least one bag; and a bag holder for holding the at least one bag, wherein the bag holder and at least one bag are proximate to the shredding apparatus. In other embodiments, the present invention further comprises a case having a top surface, four side surfaces, and a bottom surface, wherein the case is sized to accommodate the bottle holder, the wire cutter, the bottle support, the linear slide, the shredding apparatus, and the finished shreds chute, wherein the top surface is equipped with an opening and a safety door having an open position and a closed position.

Preferably, the shredder will not operate when the safety door is in the open position and preferably the first motor is an electric motor and the second motor is also an electric motor. In other embodiments the bottle support is disposed such that the wire cutter is substantially level with the neck of a bottle placed in the bottle holder. In one embodiment the case is constructed out of molded plastic. Preferably, the wire cutter is constructed out of a diamond-coated wire and the at least one shredding blade is constructed out of a chromium-molybdenum alloy steel. Further, the finished shreds chute is constructed out of stainless steel. In some embodiments, the case further comprises a side door disposed on one of the four side surfaces wherein this side door allows the bottle shredder to be refilled with at least one bag. The present invention also provides for a method of shredding bottles, comprising the steps of: providing, a bottle shredder comprising: a bottle holder, sized to receive a plastic bottle, a wire cutter, located below the bottle holder, a bottle support, located below the bottle holder, a linear slide attached to the bottle holder, capable of moving the bottle holder directly above a shredding apparatus, the shredding apparatus comprising: at least one feed roller operatively connected to a first motor, a spur gear, a bearing block, featuring at least one bearing, at least one shredding blade operatively connected to a second motor vie the spur gear and bearing block, wherein the at least one feed roller is proximate to the at least one shredding blade, a finished shreds chute, located directly below the shredding apparatus; inserting, a bottle into the bottle holder; allowing, the bottle to rest on the bottle support; removing, a cap off the bottle by the linear slide dragging the neck of the bottle along the wire cutter such that the bottle is now proximate to the at least one feed roller; feeding, the bottle into the shredding mechanism, by the at least one feed roller; shredding, the bottle, by the shredding mechanism.

In some embodiments, the bottle shredder further comprises at least one bag; and a bag holder for holding the at least one bag wherein the bag holder and at least one bag are proximate to the shredding apparatus. In some embodiments, the bottle shredder further comprises: a case having a top surface, four side surfaces, and a bottom surface, wherein the case is sized to accommodate the bottle holder, the wire cutter, the bottle support, the linear slide, the shredding apparatus, and the finished shreds chute, wherein the top surface is equipped with an opening and a safety door having an open position and a closed position. In those embodiments, the shredded bottle is allowed to fall through the bag holder into the at least one bag. In other embodiments, the method of the present invention starts by moving, the safety door, into the closed position and finishes by moving, the safety door, into the open position.

In general, the present invention succeeds in conferring the following, and others not mentioned, benefits and objectives:

It is an object of the present invention to provide an improved means for recycling plastic bottles.

It is an object of the present invention to provide a means for improving the efficiency of plastic recycling.

It is an object of the present invention to provide a means to shred bottles in a user's home.

It is an object of the present invention to reduce the cost of recycling plastic.

It is an object of the present invention to provide a means for reducing the size of plastic bottles prior to being processed for recycling.

It is an object of the present invention to provide a means for enhancing the portability of plastic to be recycled.

It is an object of the present invention to reduce the cost and improve the efficiency of transporting recycled plastic.

### BRIEF DESCRIPTION OF THE DRAWINGS

FIG. 1 shows a perspective view of an embodiment of the present invention.

FIG. 2 shows a cutaway side view of an embodiment of the present invention, showing the internals of this embodiment.

FIG. 3 shows a front view of an embodiment of the present invention.

FIG. 4 shows a top view of an embodiment of the present invention.

FIG. 5 shows a left side view of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

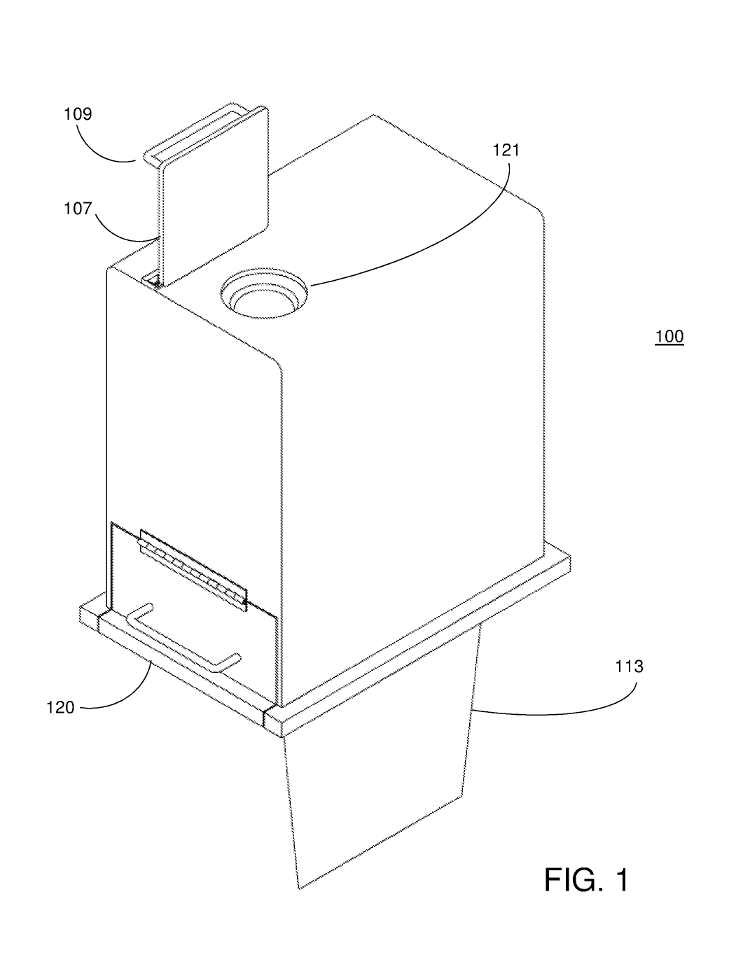

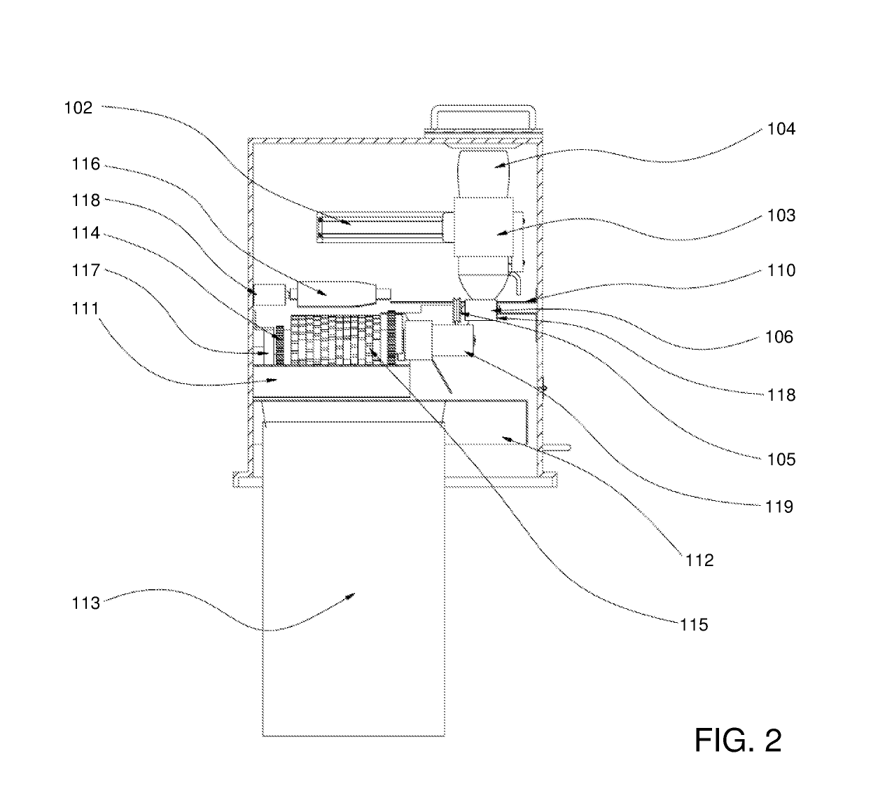

Referring to FIG. 1, a perspective view of the present invention is shown. Here, bottle shredder 100 features opening 121, safety door 107, handle 109, side safety door 120, and bag 113. Here, safety door 107 is shown in the open position. When in this position, bottle shredder 100 is unable to operate. This allows a user to safely place bottles in bottle shredder 100, as well as ensure that bottle shredder 100 will not operate while it is being serviced. Side safety door 120 operates in a similar fashion, however in FIG. 1 side safety door 120 is shown in the closed position. That said, when side safety door is in the open position, bottle shredder 100 will not operate. As such, both safety door 107 and side safety door 120 must be in the closed position for bottle shredder 100 to operate. Side safety door 120 also allows bag 113 to be replaced when it is full. Bag holder 112 (See FIG. 2) is accessible when side safety door 120 is in the open position. In some embodiments, safety door 107 operates an aperture covering opening 121. In those embodiments, when safety door 107 is in the open position, the aperture closes, preventing opening 121 from being used.

FIG. 2 shows a side view of the internals of an embodiment of the present invention. Here, the present invention features linear slide 102, bottle holder 103, wire cutter 105, bottle support 106, second motor 119, at least one bag 113, finished shreds chute 111, bearing block 117, spur gear 114, first motor 118, second motor 119, bag holder 112, at least one shredding blade 115, and at least one feed roller 116. Here linear slide 102 serves to move the bottle from the load position (above bottle support 106 and wire cutter 105), into a cutting position where the bottle, after its cap has been cut off by wire cutter 105, is placed above an embodiment of the cutting apparatus of the present invention.

Preferably, the cutting apparatus employs at least one feed roller 118. Ideally, at least one feed roller 116 will be a roller constructed from an acetal resin coated with a high-friction coating, such as Delrin® produced by DuPont, Inc. Other embodiments exist with feed rollers having various levels of friction, provided that the feed roller is capable of driving a proximate bottle into the shredding apparatus of the present invention. This embodiment of the cutting apparatus also features spur gear 114 which drives the at least one shredding blade 115. Further, the at least one shredding blade 115 is connected to bearing block 117 which features a plurality of bearings. Bearing block 117 allows at least one shredding blade 115 to spin freely, improving the efficiency of the present invention. First motor 118 drives the at least one feed roller 116 and second motor 119 drives the at least at least one shredding blade 115. Preferably these motors are electric, but any suitable power source may be used. Once a bottle is in the shredding apparatus of the present invention, it is shredded by the at least one shredding blade 115 such that the resulting shreds are roughly ½″ to ⅜″. Note that the configuration of the at least one shredding blade 115 may be adjusted to change the size of the shreds that are produced. Once the bottle had moved through the shredding apparatus of the present invention, the resulting shreds will pass through finished shreds chute 111, which guides the shreds into bag holder 112 and into at least one bag 113. Once at least one bag 113 is filled, it can be easily and quickly replaced so that the present invention may continue to operate.

In a preferred embodiment, the present invention is optimized to receive 500 mL plastic bottles. Other embodiments exist where the present invention is optimized for bottles ranging from 200 mL-2 L bottles. Other embodiments also exist where the present invention is not optimized for a particular size, and is capable of accepting a variety of sizes of plastic bottles.

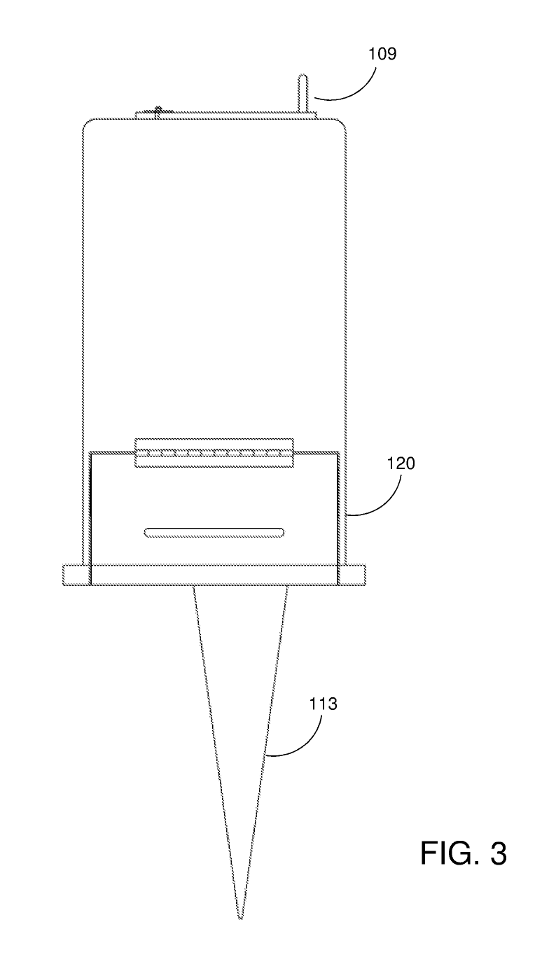

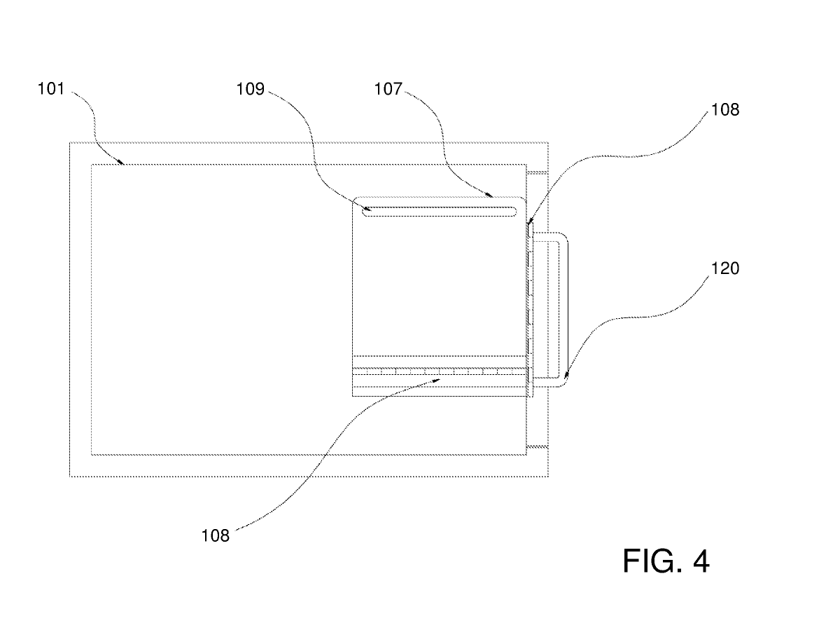

Referring to FIG. 3, a front view of an embodiment of the present invention is shown. Here, like in FIG. 1, handle 109, at least one bag 113, and side safety door 120 are shown. In particular, this view is provided so that the attachment mechanism of side safety door 120 to the case 101 (See FIG. 4) of the present invention can be plainly seen. While it is shown as a simple hinge here, side safety door 120 may be slid open, or may be temporarily detached.

Referring to FIG. 4, a top view of an embodiment of the present invention is shown. Here, the present invention features case 101, hinges 108, handle 109, safety door 107, and side safety door 120. The present invention can be constructed out of a wide variety of materials including molded plastic, acetal resin, diamond-coated wire, tool steel, stainless steel, and chromium-molybdenum alloy steel (“4140 cold finished annealed steel”). While some combination of these materials can be used for each component, an exemplary embodiment of the present invention has case 101, handle 109, safety door 107, and opening 121 constructed out of molded plastic; wire cutter 105 out of diamond-coated wire; bottle holder 103 and at least one feed roller 116 out of an acetal resin, preferably Delrin®; spur gear 114 out of tool steel; bottle guide 110, finished shreds chute 111, bag holder 112, bottle support 106, and bearing block 117 out of stainless steel; and at least one shredder blade 115 out of chromium-molybdenum alloy steel.

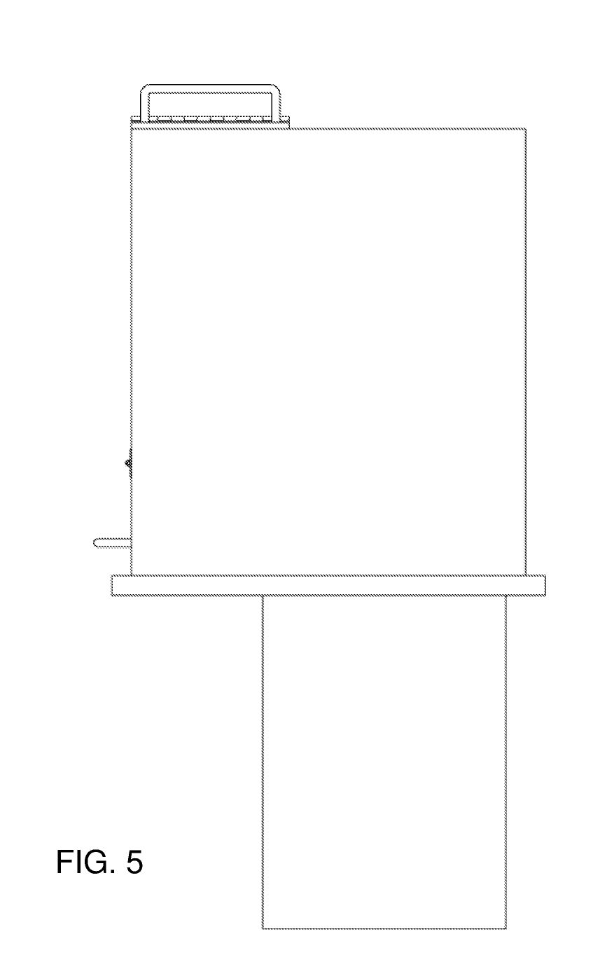

FIG. 5 shows an alternative side view of an embodiment of the present invention.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A bottle shredder, comprising:
a bottle holder, sized to receive a plastic bottle;
a wire cutter, located below the bottle holder;
a bottle support, located below the bottle holder;
a linear slide attached to the bottle holder, capable of moving the bottle holder directly above a shredding apparatus, the shredding apparatus comprising:
at least one feed roller operatively connected to a first motor,
a spur gear,
a bearing block, featuring at least one bearing,
at least one shredding blade operatively connected to a second motor via
the spur gear and bearing block,
wherein the at least one feed roller is proximate to the at least one shredding blade;
a finished shreds chute, located directly below the shredding apparatus.

2. The bottle shredder of claim 1, further comprising:
at least one bag; and
a bag holder for holding the at least one bag.
wherein the bag holder and at least one bag are proximate to the shredding apparatus.

3. The bottle shredder of claim 1, further comprising:
a case having a top surface, four side surfaces, and a bottom surface,
wherein the case is sized to accommodate the bottle holder, the wire cutter, the bottle support, the linear slide, the shredding apparatus, and the finished shreds chute,
wherein the top surface is equipped with an opening and a safety door having an open position and a closed position.

4. The bottle shredder of claim 3, wherein the shredder will not operate when the safety door is in the open position.

5. The bottle shredder of claim 1, wherein the first motor is an electric motor and the second motor is an electric motor.

6. The bottle shredder of claim 1, wherein the bottle support is disposed such that the wire cutter is substantially level with the neck of a bottle placed in the bottle holder.

7. The bottle shredder of claim 1, wherein the case is constructed out of molded plastic.

8. The bottle shredder of claim 1, wherein the wire cutter is constructed out of a diamond-coated wire.

9. The bottle shredder of claim 1, wherein the at least one shredding blade is constructed out of a chromium-molybdenum alloy steel.

10. The bottle shredder of claim 1, wherein the finished shreds chute is constructed out of stainless steel.

11. The bottle shredder of claim 3, the case further comprising a side door disposed on one of the four side surfaces.

12. The bottle shredder of claim 11, wherein the side door allows the bottle shredder to be refilled with at least one bag.

13. A method of shredding bottles, comprising the steps of:
providing, a bottle shredder comprising:
a bottle holder, sized to receive a plastic bottle,
a wire cutter, located below the bottle holder,
a bottle support, located below the bottle holder,
a linear slide attached to the bottle holder, capable of moving the bottle holder directly above a shredding apparatus, the shredding apparatus comprising:
at least one feed roller operatively connected to a first motor,
a spur gear,
a bearing block, featuring at least one bearing,
at least one shredding blade operatively connected to a second motor via the spur gear and bearing block,
wherein the at least one feed roller is proximate to the at least one shredding blade,
a finished shreds chute, located directly below the shredding apparatus;
inserting, a bottle into the bottle holder;
allowing, the bottle to rest on the bottle support;
removing, a cap off the bottle by the linear slide dragging the neck of the bottle along the wire cutter such that the bottle is now proximate to the at least one feed roller; and
feeding, the bottle into the shredding mechanism, by the at least one feed roller;
shredding, the bottle, by the shredding mechanism.

14. The method of claim 13, the bottle shredder, further comprising:
at least one bag; and
a bag holder for holding the at least one bag.
wherein the bag holder and at least one bag are proximate to the shredding apparatus.

15. The method of claim 13, the bottle shredder further comprising:
a case having a top surface, four side surfaces, and a bottom surface,
wherein the case is sized to accommodate the bottle holder, the wire cutter, the bottle support, the linear slide, the shredding apparatus, and the finished shreds chute,
wherein the top surface is equipped with an opening and a safety door having an open position and a closed position.

16. The method of claim 14, further comprising the step of:
allowing, the shredded bottle to fall through the bag holder into the at least one bag.

17. The method of claim 15, further comprising an initial step of:
moving, the safety door, into the closed position.

18. The method of claim 17, further comprising a final step of:
moving, the safety door, into the open position.

19. The method of claim 17, wherein the method takes no longer than two seconds to perform.
